(19) United States
(12) Patent Application Publication
(10) Pub. No.: US 2014/0378559 A1
(43) Pub. Date: Dec. 25, 2014

(54) COMPOSITIONS OF 1,1,1,3,3-PENTAFLUOROPROPANE AND CYCLOPENTANE

(71) Applicants: Jun Liu, Morristown, NJ (US); Sanglu Qin, Morristown, NJ (US); Xiangrui Wang, Morristown, NJ (US); Xia Cao, Morristown, NJ (US); Ryan Hulse, Getzville, NY (US); Yunjie Xing, Morristown, NJ (US); Zhongxi Huang, Morristown, NJ (US); Zhili Lu, Morristown, NJ (US)

(72) Inventors: Jun Liu, Morristown, NJ (US); Sanglu Qin, Morristown, NJ (US); Xiangrui Wang, Morristown, NJ (US); Xia Cao, Morristown, NJ (US); Ryan Hulse, Getzville, NY (US); Yunjie Xing, Morristown, NJ (US); Zhongxi Huang, Morristown, NJ (US); Zhili Lu, Morristown, NJ (US)

(73) Assignee: Honeywell International Inc., Morristown, NJ (US)

(21) Appl. No.: 14/368,990

(22) PCT Filed: Dec. 19, 2011
(86) PCT No.: PCT/CN2011/002121

§ 371 Date: Sep. 11, 2014

(51) Int. Cl. B01F 17/00; C09K 3/30

(52) U.S. Cl. CPC B01F 17/0035; C09K 3/30
USPC 516/8; 516/12

(57) ABSTRACT

A composition comprising HFC-245fa, cyclopentane, and a third solvent component, wherein the composition is in a homogenous one-phase solution state at temperatures less than the boiling temperature of the composition, and uses thereof, including as blowing agents.

### FIELD OF THE INVENTION

The present invention relates generally to compositions including 1,1,1,3,3-pentafluoropropane and cyclopentane. The compositions of the invention are useful, inter alia, as blowing agents in the manufacture of rigid and flexible polyurethane foams and polyisocyanurate foams as well as aerosol propellants.

### BACKGROUND OF THE INVENTION

Rigid polyurethane and polyisocyanurate foams are manufactured by reacting and foaming a mixture of ingredients, in general an organic polyisocyanate with a polyol or mixture of polyols, in the presence of a volatile liquid blowing agent. The blowing agent is vaporized by the heat liberated during the reaction of isocyanate and polyol causing the polymerizing mixture of foam. This reaction and foaming process may be enhanced through the use of various additives such as amine or tin catalysts and surfactant materials that serve to control and adjust cell size and to stabilize the foam structure during formation. Foams made with blowing agents such as CCl₃F (“CFC-11”) and CCl2FCH₃ (“HCFC-141b”) offer excellent thermal insulation, due in part to the very low thermal conductivity of CFC-11 and HCFC-141b vapor, and are used widely in insulation applications.

Flexible polyurethane foams are generally open-cell foams manufactured using an excess of diisocyanate that reacts with water, also included as a raw material, producing gaseous carbon dioxide and causing foam expansion. The flexible foams are widely used as cushioning materials in items such as furniture, bedding, and automobile seats. Auxiliary physical blowing agents such as methylene chloride and/or CFC-11 are required in addition to the water/diisocyanate blowing mechanism in order to produce low density, soft grades of foam.

Many foam producers have converted from chlorofluorocarbon (“CFC”) blowing agents, such as CFC-11, to environmentally safer hydrochlorofluorocarbon (“HCFC”) agents and hydrocarbons. However, HCFCs, such as HCFC-141b, also have some propensity to deplete stratospheric ozone albeit significantly less than that of the CFCs.

Hydrocarbon agents, such as n-pentane, isopentane, and cyclopentane, do not deplete stratospheric ozone, but are not optimal agents because foams produced from these blowing agents lack the same degree of thermal insulation efficiency as foams made with the CFC or HCFC blowing agents. Further, the hydrocarbon blowing agents are extremely flammable. Because rigid polyurethane foams must comply with building code or other regulations, foams expanded with a blowing agent composed only of hydrocarbons often require addition of expensive flame retardant materials to meet the regulations. Finally, hydrocarbon blowing agents are classified as Volatile Organic Compounds and present environmental issues associated with photochemical smog production in the lower atmosphere.

In contrast to the foregoing blowing agents, hydrofluorocarbons (“HFCs”) such as 1,1,1,3,3-pentafluoropropane (“HFC-245fa”) do not deplete stratospheric ozone. In addition, azeotrope-like compositions based on HFC-245fa and hydrocarbons can be used as blowing agents for polyurethane-type foams.

Azeotropic blowing agents possess certain advantages such as more efficient blowing than the individual components, lower thermal conductivity or K-factor, and better compatibility with other foam raw materials. Additionally, azeotropic or azeotrope-like compositions are desirable because they do not fractionate upon boiling or evaporation. This behavior is especially important where one component of the blowing agent is very flammable and the other component is nonflammable because minimizing fractionation during a leak or accidental spill minimizes the risk of producing extremely flammable mixtures.

Certain azeotropic or azeotrope-like compositions used as blowing agents for the production of polyurethane, such as those containing HFC-245fa and cyclopentane, are heteroazeotropes that phase separate into two liquid layers with different compositions of HFC-245fa and cyclopentane at low temperature. Applicants have come to appreciate that such heteroazeotropic behavior makes it difficult, if not impossible, to premix HFC-245fa and cyclopentane, and then charge it as a single fluid if the process temperature is low.

Accordingly, this invention provides compositions that are environmentally safe substitutes for CFC and HCFC blowing agents, that have a reduced propensity for photochemical smog production, and that produce rigid and flexible polyurethane foams and polyisocyanurate foams with good properties. The invention also provides blowing agent compositions with reduced flammability hazards compared to hydrocarbon blowing agents. Foams made with the blowing agent compositions of this invention exhibit improved properties, such as thermal insulation efficiency, improved solubility in foam raw materials, and foam dimensional stability, when compared to foams made with hydrocarbon blowing agents alone.

SUMMARY OF INVENTION

The present invention relates, in part, to methods of improving miscibility of HFC-245fa and cyclopentane, and to uses of such compositions as blowing agents and in foamable compositions. When stored as a mixture HFC-245fa and cyclopentane can form a two-phase or heterogeneous system. It is advantages for consistent processing that the blowing agent mixture is a single phase or homogenous solution.

In one aspect, the present invention relates to compositions containing effective amounts of HFC-245fa and cyclopentane, and a third solvent component, wherein the composition is in a homogeneous one-phase solution state at temperatures less than the boiling temperature of the composition. In certain embodiments, the third solvent component includes an alcohol, an ether, an ester, trans-1,1-dichloroethylene, trans-1-chloro-3,3,3-trifluoroprop-1-ene, silicone, toluene, dipropylene glycol and combinations of these. In certain other embodiments, the third solvent component includes ethanol, 2-propanol, dipropylene glycol, methylal, ethylal, diethlyene glycol monomethyl ether, ethyl acetate, methyl formate, 1-chloro-3,3,3-trifluoropropene, trans-1,2-dichloroethene, toluene, silicone surfactant, and combinations thereof. In certain embodiments, the third solvent component includes methyl formate in an amount from about 7 weight percent or more based on the total amount of HFC-245fa and cyclopentane.

In another aspect, the present invention relates to blowing agents including such compositions. Such blowing agents may be used in foamable compositions or with a foam forming agent and may also include one or more of the additional ingredients provided below.

### BRIEF DESCRIPTION OF THE FIGURES

FIG. 1 provides phase diagram of a compositions including HFC-245fa and cyclopentane.

FIG. 2 provides a miscibility diagram of a composition including HFC-245fa, cyclopentane, and methyl formate at 3° C.

FIG. 3 provides a miscibility diagram of a composition including HFC-245fa, cyclopentane, and methyl formate at −5° C.

### DETAILED DESCRIPTION OF PREFERRED EMBODIMENTS

This invention provides compositions including HFC-245fa, cyclopentane, and a third solvent component, wherein the third solvent component is present in an amount effective to achieve or otherwise improve miscibility between HFC-245fa and cyclopentane, particularly at temperatures below the boiling point of the composition. Such compositions are useful, inter alia, as blowing agents for thermoplastic and/or thermoset foams.

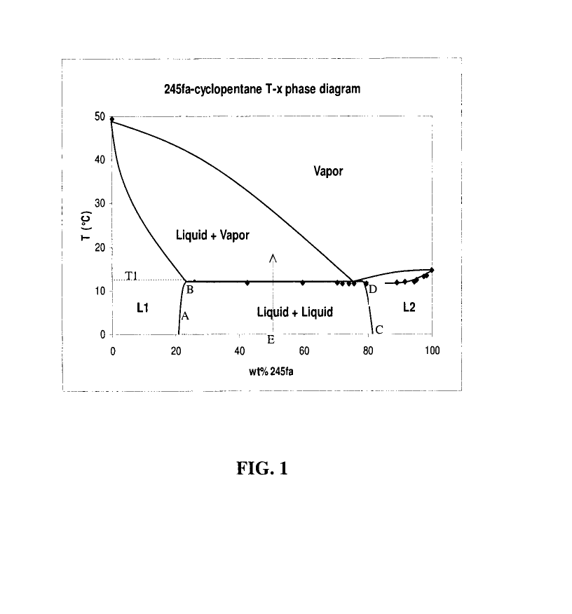

Hydrofluorocarbon/hydrocarbon blends are of interest for use as replacements for chlorofluorocarbon and/or hydrochlorofluorocarbon compositions, which tend to be environmentally undesirable. In particular, compositions including mixtures of 1,1,1,3,3-pentafluoropropane (HFC-245fa) and hydrocarbons are of interest for use as blowing agent for the production of thermal-insulating polyurethane (PU) foam. However, Applicants have identified disadvantages associated with hydrofluorocarbon/hydrocarbon blends. More particularly, Applicants have identified that 1,1,1,3,3-pentafluoropropane/cyclopentane (HFC-245fa/CP) blend can exhibit heteroazeotropic properties. More particularly, a mixture of HFC-245fa/CP does not mix at low temperatures (i.e. below the boiling point of the composition), but instead forms two liquid phases. One phase is rich in HFC-245fa, and the other is rich in cyclopentane. Referring to FIG. 1, for example, a 50/50 wt/wt HFC-245fa/CP blends (point “E” in FIG. 1) is illustrated as forming two liquid phases, the upper phase has a composition on the line “AB” while the lower phase has a composition on the line “CD”. When temperature is increased to above T1, the mixture will start to boil and one of the liquid phases will disappear.

HFC-245fa compositions are primarily used in the liquid phase. Due to the low boiling point of HFC-245fa, however, such material must be cooled or pressurized to accommodate transfer in this phase. However, the HFC-245fa/CP blend has an even lower boiling point than pure HFC-245fa. When the composition is cooled down to a temperature lower than boiling point, the blend phase separates. This heteroazeotropic behavior makes it very difficult, if not impossible, to operate the HFC-245fa/CP blends. It also makes it difficult when HFC-245fa/CP blends are stored at low temperature and the delivery of a specified component ratio is required.

Applicants have surprisingly discovered that adding a co-solvent to the HFC-245fa/CP blends results in a ternary mixture being a one-phase homogenous solution. Accordingly, the present invention provides compositions including pentafluoropropane, cyclopentane, and a third solvent component. The amount of the third solvent component is sufficient so that the composition stays as a one-phase mixture below the boiling point of the composition. In certain embodiments the third component includes one or a combination of alcohols, ethers, esters, trans-1,1-dichloroethylene, trans-l-chloro-3,3,3-trifluoroprop-1-ene, silicone, toluene, dipropylene glycol. Such solvents may include, but are not limited to, one or a combination of ethanol, 2-propanol, dipropylene glycol, methylal, ethylal, diethlyene glycol monomethyl ether, ethyl acetate, methyl formate, 1-chloro-3,3,3-trifluoropropene, trans-1,2-dichloroethene, toluene, and/or a silicone surfactant. Such mixtures may be provided for a variety of uses including, but not limited to, as blowing agents, in foam compositions, refrigerants, polyol premixes, closed-cell foams, sprayable compositions, and the like. In certain embodiments, as provided in greater detail below, the compositions of the present invention are provided as blowing agents, particularly in foaming applications, compositions, and premixes.

One of skill in the art will appreciate that HFC-245fa and cyclopentane may be provided in any amount to achieve the desired functionality and based on the contribution of each component (e.g. volatility, flammability, toxicity, etc.) to the composition. In certain non-limiting embodiments, the compositions may include an amount of HFC-245fa and cyclopentane that result in an azeotropic or azeotrope-like composition. In certain embodiments, such compositions include from about 5 to about 60 percent by weight cyclopentane and from about 95 to about 40 percent by weight HFC-245fa and have a boiling point of about 11.7±1° C. at 745 mm Hg. In a preferred embodiment, such compositions include from about 5 to about 40 percent by weight cyclopentane and from about 95 to about 60 percent by weight HFC-245fa and have a boiling point of about 11.7±0.5° C. at 745 mm Hg.

In view of the teachings contained herein, it is expected that those skilled in the art will be able to determine the relative amount of a third solvent component to be used to provide an effective amount to achieve one or more of the foregoing advantages discussed herein. In addition, one skilled in the art will understand that the effective amount of the third solvent component present in any of the inventive compositions contained herein will be dependent upon the amount of HFC-245fa and cyclopentane present in such compositions at a specified temperature and pressure. Accordingly, “an effective amount” of solvent, as used herein, means any amount of the third solvent component required to achieve or otherwise improve the miscibility of compositions including HFC-245fa and cyclopentane, or to result in such compositions remaining as a homogeneous one-phase mixture, particularly below the boiling point of the composition. For example, in certain non-limiting compositions the third solvent component is provided in an amount from about 1 to about 40 percent by weight. In other embodiments of such compositions, the compositions include the third solvent component in an amount from about 1 to about 10% by weight.

As is discussed above, compositions including HFC-245fa and cyclopentane can be heteroazeotropic. Dependent upon the amounts provided for each ingredient, compositions of the present invention including the third solvent component may form an azeotropic composition. Such azeotropes may include a ternary azeotropic composition of three components or the third component may form alternative binary azeotropic compositions with HFC-245fa and/or cyclopentane. In even further embodiments, the composition may be non-azeotropic.

As used herein, an azeotrope is a unique characteristic of a system of two or more components in which the liquid and vapor compositions are equal at a stated pressure and temperature. In practice this means that the components cannot be separated during a phase change. With respect to those inventive compositions that are azeotrope-like, all compositions of the invention within the indicated ranges, as well as certain compositions outside the indicated ranges, are considered to be azeotrope-like. For the purposes of the invention, by azeotrope-like composition is meant that the composition behaves like a true azeotrope in terms of this constant boiling characteristic or tendency not to fractionate upon boiling or evaporation. Thus, in such systems, the composition of the vapor formed during the evaporation is identical, or substantially identical, to the original liquid composition. During boiling or evaporation of azeotrope-like compositions, the liquid composition, if it changes at all, changes only slightly. This is contrasted with non-azeotrope-like compositions in which the liquid and vapor compositions change substantially during evaporation or condensation.

One way to determine whether a candidate mixture is azeotrope-like within the meaning of this invention, is to distill a sample thereof under conditions, i.e., resolution-number of plates, that would be expected to separate the mixture into its separate components. If the mixture is non-azeotropic or non-azeotrope-like, the mixture will fractionate, or separate into its various components, with the lowest boiling component distilling off first, and so on. If the mixture is azeotrope-like, some finite amount of the first distillation cut will be obtained which contains all of the mixture components and which is constant boiling or behaves as a single substance. This phenomenon cannot occur if the mixture is not azeotrope-like, or not part of an azeotropic system.

Another characteristic of azeotrope-like compositions is that there is a range of compositions containing the same components in varying proportions which are azeotrope-like. All such compositions are intended to be covered by the term azeotrope-like as used herein. As an example, it is well known that at different pressures the composition of a given azeotrope will vary at least slightly as does the boiling point of the composition. Thus, an azeotrope of A and B represents a unique type of relationship but with a variable composition depending on the temperature and/or pressure.

The compositions of the invention exhibit zero ozone depletion and low global warming potential. Further, the HFC-245fa component reduces the flammability hazard associated with handling and using the composition, especially when compared to the use of the hydrocarbon component alone. Accordingly, in ne aspect of the present invention, the compositions may be used as blowing agents, which may be provided for a wide array of uses including in foamable compositions and premixes.

As is known to those skilled in the art, such foamable compositions generally include one or more components capable of forming foam. As used herein, the term “foam forming agent” is used to refer to a component, or a combination of components, which are capable of forming a foam structure, preferably a generally cellular foam structure. The foamable compositions of the present invention include such component(s) and a blowing agent compound in accordance with the present invention.

In certain embodiments, the foam forming agents include a thermosetting composition capable of forming foam and/or foamable compositions. Examples of thermosetting compositions include polyurethane and polyisocyanurate foam compositions, and also phenolic foam compositions. This reaction and foaming process may be enhanced through the use of various additives such as catalysts and surfactant materials that serve to control and adjust cell size and to stabilize the foam structure during formation. Furthermore, is contemplated that any one or more of the additional components described above with respect to the blowing agent compositions of the present invention could be incorporated into the foamable composition of the present invention. In such thermosetting foam embodiments, one or more of the present compositions are included as or part of a blowing agent in a foamable composition, or as a part of a two or more part foamable composition, which preferably includes one or more of the components capable of reacting and/or foaming under the proper conditions to form a foam or cellular structure.

In certain other embodiments of the present invention, the foam forming agents include thermoplastic materials, particularly thermoplastic polymers and/or resins. Examples of thermoplastic foam components include polyolefins, such as for example monovinyl aromatic compounds of the formula Ar—CHCH₂ wherein Ar is an aromatic hydrocarbon radical of the benzene series such as polystyrene (PS). Other examples of suitable polyolefin resins in accordance with the invention include the various ethylene resins including the ethylene homopolymers such as polyethylene and ethylene copolymers, polypropylene (PP) and polyethyleneterepthalate (PET). In certain embodiments, the thermoplastic foamable composition is an extrudable composition.

Polyurethane foams expanded with the blowing agents of the invention exhibit superior performance to foams expanded with the hydrocarbon blowing agent alone. The thermal conductivity of foams prepared using the compositions of the invention is lower, hence superior, when compared to the thermal conductivity of foams expanded with just the hydrocarbon blowing agent. Improved dimensional stability, especially at low temperature, is also observed.

In the process embodiments of the invention, the compositions of the invention may be used in methods for producing rigid closed-cell polyurethane, a flexible open-cell polyurethane, or polyisocyanurate foam. With respect to the preparation of rigid or flexible polyurethane or polyisocyanurate foams using the compositions described in the invention, any of the methods well known in the art can be employed. See Saunders and Frisch, Volumes I and II Polyurethanes Chemistry and Technology (1962).

In general, polyurethane or polyisocyanurate foams are prepared by combining a blowing agent and a foam forming agent. An isocyanate, a polyol or mixture of polyols, a blowing agent or mixture of blowing agents, and other materials such as catalysts, surfactants, and optionally, flame retardants, colorants, or other additives.

It is convenient in many applications to provide the components for polyurethane or polyisocyanurate foams in preblended formulations. Most typically, the foam formulation is preblended into two components. The isocyanate, optionally certain surfactants, and blowing agents include the first component, commonly referred to as the “A” component. The polyol or polyol mixture, surfactant, catalysts, blowing agents, flame retardant, and other isocyanate reactive components include the second component, commonly referred to as the “B” component. Accordingly, polyurethane or polyisocyanurate foams are readily prepared by bringing together the A and B side components either by hand mix, for small preparations, or preferably machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a third stream to the mix head or reaction site. Most conveniently, however, they are all incorporated into one B component.

Any organic polyisocyanate can be employed in polyurethane or polyisocyanurate foam synthesis inclusive of aliphatic and aromatic polyisocyanates. Preferred as a class are the aromatic polyisocyanates. Preferred polyisocyanates for rigid polyurethane or polyisocyanurate foam synthesis are the polymethylene polyphenyl isocyanates, particularly the mixtures containing from about 30 to about 85 percent by weight of methylenebis(phenyl isocyanate) with the remainder of the mixture including the polymethylene polyphenyl polyisocyanates of functionality higher than 2. Preferred polyisocyanates for flexible polyurethane foam synthesis are toluene diisocyantes including, without limitation, 2,4-toluene diisocyanate, 2,6-toluene diisocyanate, and mixtures thereof.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Typical polyols used in the manufacture of flexible polyurethane foams include, but are not limited to, those based on glycerol, ethylene glycol, trimethylolpropane, ethylene diamine, pentaerythritol, and the like condensed with ethylene oxide, propylene oxide, butylene oxide, and the like. These are generally referred to as “polyether polyols.” Another example is the graft copolymer polyols which include, but are not limited to, conventional polyether polyols with vinyl polymer grafted to the polyether polyol chain. Yet another example is polyurea modified polyols which consist of conventional polyether polyols with polyurea particles dispersed in the polyol.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose based polyols, and used in polyurethane foam applications.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as hetrocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcycolhexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts are used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic acid salts, and mixtures thereof. Preferred species within the classes are potassium acetate, potassium octoate, and N-(2-hydroxy-5-nonylphenol)methyl-N-methylglycinate.

Dispersing agents, cell stabilizers, and surfactants may be incorporated into the present blends. Surfactants, better known as silicone oils, are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458.

Other optional additives for the blends may include flame retardants such as tris(2-chloroethyl)phosphate, tris(2-chloropropyl)phosphate, tris(2,3-dibromopropyl)phosphate, tris(1,3-dichloropropyl)phosphate, diammonium phosphate, various halogenated aromatic compounds, antimony oxide, aluminum trihydrate, polyvinyl chloride, and the like. Other optional ingredients may include from 0 to about 3 percent water, which chemically reacts with the isocyanate to produce carbon dioxide. The carbon dioxide acts as an auxiliary blowing agent.

Also included in the mixture are blowing agents or blowing agent blends as disclosed in this invention. Generally speaking, the amount of blowing agent present in the blended mixture is dictated by the desired foam densities of the final polyurethane or polyisocyanurate foams products. The proportions in parts by weight of the total blowing agent blend can fall within the range of from 1 to about 45 parts of blowing agent per 100 parts of polyol, preferably from about 4 to about 30 parts.

The polyurethane foams produced can vary in density from about 0.5 pound per cubic foot to about 40 pounds per cubic foot, preferably from about 1.0 to about 20.0 pounds per cubic foot, and most preferably from about 1.5 to about 6.0 pounds per cubic foot for rigid polyurethane foams and from about 1.0 to about 4.0 pounds per cubic foot for flexible foams. The density obtained is a function of how much of the blowing agent, or blowing agent mixture, of the invention is present in the A and/or B components, or that is added at the time the foam is prepared.

The HFC-245fa component of the novel azeotrope-like compositions of the invention is a known material and can be prepared by methods known in the art such as those disclosed in WO 94/14736, WO 94/29251, WO 94/29252. The cyclopentane component is a known material that is available commercially and is used in various grades ranging from 75% to 99% purities. For the purposes of the present invention cyclopentane refers to all such commercial grades of material.

### EXAMPLES

The invention is further illustrated in the following example which is intended to be illustrative, but not limiting in any manner.

### Example 1

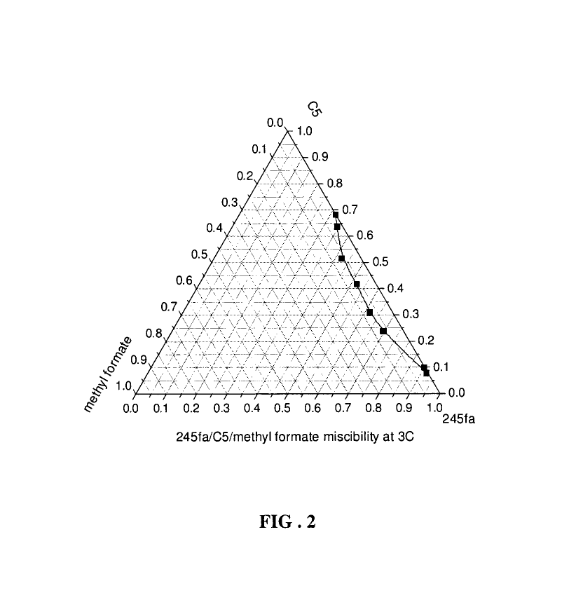

HFC-245fa/CP mixture with different composition was cooled to certain temperature. If the binary mixture stayed in two phases, one rich with HFC-245fa and the other rich with CP, a third solvent was titrated to the two-phase HFC-245fa/CP mixture until one of the two phases disappeared. As shown in the FIG. 2, at 3° C., HFC-245fa/CP stays in two phases if HFC-245fa contents are between about 30% by weight to about 92% by weight. When methyl formate is added to the two-phase mixture, the immiscible HFC-245fa/CP concentration range shrinks. If methyl formate content is higher than about 7% by weight in the HFC-245fa/CP/methyl formate blend, the mixture becomes miscible or one-phase.

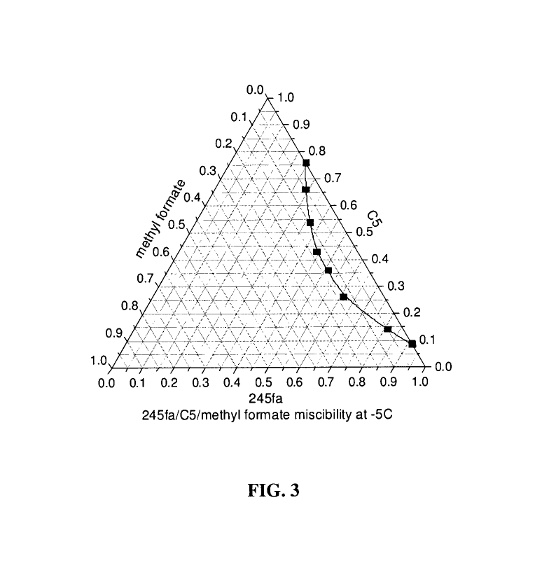

FIG. 3 shows the phase diagram of the HFC-245fa/CP/methyl formate ternary blend measured under −5° C. The immiscible area enlarges as temperature decreases. When the composition ratios of HFC-245fa/CP are the same, more methyl formate is required to enable miscibility of HFC-245fa/CP/methyl formate at lower temperature.

### Example 2

A 50%/50% by weight HFC-245/CP blend was cooled to 4° C. and the mixture stayed in two phases. The two-phase mixture became one-phase when some of the solvents listed in Table 1 was added and the concentration of the third solvent was high enough. For example, when 5.5 g of ethanol was added to 100 g of 50/50 wt/wt HFC-245/CP blend, the resulted ternary mixture was in a one-phase homogeneous state. However, not all solvents tested resulted in improved miscibility of the HFC-245/CP blend. Table 1 lists test results for more solvents.

The preferred third solvents include ethanol, 2-propanol, dipropylene glycol, methylal, ethylal, diethlyene glycol monomethyl ether, ethyl acetate, methyl formate, 1-chloro-3,3,3-trifluoropropene, trans-1,2-dichloroethene, toluene, silicone surfactant.

TABLE 1
HFC-245fa/CP miscibility test results

| | | | Co-solvent |
|---|---|---|---|
| | | | amount* |
| Co-solvent | Structure | Miscible | (wt %) |
| Methanol | CH₃OH | YES | 34.2% |
| Ethanol | CH₃CH₂OH | YES | 5.5% |
| 2-Propanol | CH₃CH(CH₃)OH | YES | 2.9% |
| n-butanol | CH₃CH₂CH₂CH₂OH | NO | — |
| Glycerin | HOCH₂CH(OH)CH₂OH | NO | — |
| Propylene glycol | CH₃CH(OH)CH₂OH | NO | — |
| DPG(Dipropylene | Mixture | YES | 2.5% |
| glycol) | | | |
| Methylal | CH₃OCH₂OCH₃ | YES | 2.7% |
| (dimethoxymethane) | | | |
| Ethylal | CH₃CH₂OCH₂OCH₂CH₃ | YES | 2.3% |
| (Diethoxymethane) | | | |
| Diethlyene glycol | CH₃OCH₂CH₂OCH₂CH₂OH | YES | 3.9% |
| monomethyl ether | | | |
| Ethyl acetate | CH₃COOCH₂CH₃ | YES | 3.0% |
| Methyl formate | HCOOCH₃ | YES | 7.0% |
| 1-Chloro-3,3,3- | trans-CHCl═CHCF₃ | YES | 2.5% |
| trifluoropropene | | | |
| (1233zd) | | | |
| Trans-1,2- | trans-CHCl═CHCl | YES | ═5.9% |
| dichloroethene | | | |
| 1,1,1,3,3- | CH₃CF₂CH₂CF₃ | YES | 34.9% |
| pentafluorobutane | | | |
| (HFC-365mfc) | | | |
| Toluene | PhCH₃ | YES | 4.3% |
| Silicone surfactant | | YES | 8.0% |
| (L6988) | | | |

*Based on the total amount of HFC-245fa/CP.

What is claimed is:

1. A composition comprising effective amounts of HFC-245fa, and cyclopentane, and a third solvent component, wherein the composition is in a homogenous one-phase solution state at temperatures less than the boiling temperature of the composition.

2. The composition of claim 1, wherein the third solvent component is selected from the group consisting of an alcohol, an ether, an ester, trans-1,1-dichloroethylene, trans-1-chloro-3,3,3-trifluoroprop-1-ene, silicone, toluene, dipropylene glycol and combinations of these.

3. The composition of claim 1, wherein the third solvent component is selected from the group consisting of ethanol, 2-propanol, dipropylene glycol, methylal, ethylal, diethlyene glycol monomethyl ether, ethyl acetate, methyl formate, 1-chloro-3,3,3-trifluoropropene, trans-1,2-dichloroethene, toluene, silicone surfactant.

4. The composition of claim 1, wherein the third solvent component comprises methyl formate in an amount of from about 7 weight percent or more based on the total amount of HFC-245fa and cyclopentane.

5. A blowing agent comprising effective amounts of HFC-245fa, and cyclopentane, and a third solvent component, wherein the composition is in a homogenous one-phase solution state at temperatures less than the boiling temperature of the composition.

6. The blowing agent of claim 5, wherein the third solvent component is selected from the group consisting of an alcohol, an ether, an ester, trans-1,1-dichloroethylene, trans-1-chloro-3,3,3-trifluoroprop-1-ene, silicone, toluene, dipropylene glycol and combinations of these.

7. The blowing agent of claim 5, wherein the third solvent component is selected from the group consisting of ethanol, 2-propanol, dipropylene glycol, methylal, ethylal, diethlyene glycol monomethyl ether, ethyl acetate, methyl formate, 1-chloro-3,3,3-trifluoropropene, trans-1,2-dichloroethene, toluene, silicone surfactant.

8. A foamable composition comprising a foam forming agent and a blowing agent comprising HFC-245fa, cyclopentane, and a third solvent component, wherein the blowing agent is in a homogenous one-phase solution state at temperatures less than the boiling temperature of the composition.

9. The foamable composition of claim 8, wherein the third solvent component is selected from the group consisting of an alcohol, an ether, an ester, trans-1,1-dichloroethylene, trans-1-chloro-3,3,3-trifluoroprop-1-ene, silicone, toluene, dipropylene glycol and combinations of these.

10. The foamable composition of claim 8, wherein the third solvent component is selected from the group consisting of ethanol, 2-propanol, dipropylene glycol, methylal, ethylal, diethlyene glycol monomethyl ether, ethyl acetate, methyl formate, 1-chloro-3,3,3-trifluoropropene, trans-1,2-dichloroethene, toluene, silicone surfactant.

11. The foamable composition of claim 1, wherein the third solvent component is provided in an amount between about 1% and about 40%.

12. The foamable composition of claim 1, wherein the third solvent component is provided in an amount between about 1% and about 10%.
